(19) United States
(12) Patent Application Publication
(10) Pub. No.: US 2009/0164184 A1
(43) Pub. Date: Jun. 25, 2009

(54) Method and System for Implementing a Complex System or Process

(75) Inventors: Ted Vucurevich, Los Gatos, CA (US); Louis K. Scheffer, Campbell, CA (US)

Correspondence Address: VISTA IP LAW GROUP LLP, 1885 Lundy Avenue, Suite 108, SAN JOSE, CA, 95131, US

(73) Assignee: CADENCE DESIGN SYSTEMS, INC., San Jose, CA (US)

(21) Appl. No.: 12/340,667

(22) Filed: Dec. 20, 2008

Related U.S. Application Data
(60) Provisional application No. 61/016,428, filed on Dec. 21, 2007.

(51) Int. Cl. G06G 7/48

(52) U.S. Cl. 703/6

(57) ABSTRACT

The present approach models a process as a series of steps corresponding to sets of inputs and outputs, where the inputs relates to various configurations of elements for a given step of the process. For each step in the process, one or more models are constructed that correspond to the possible parameters and samples associated with specific stages of the process. Sampling is performed to generate raw data for the models. Experimentation is performed on a significant scale to identify a set of configurations setting that should be retained for a subsequent step of the process. The selection of configuration setting for each stage of the process is not intended to prune parametric options from the process. Instead, reductions are performed which both preserve uniform and reasonably maximal coverage of data over the intended design space, while at the same time selecting configurations that achieve the desired results. In this way, the invention preserves all reasonable parametric options through all stages of the design process while also working towards an optimal solution.

### CROSS-REFERENCE TO RELATED APPLICATIONS

The present application claims the benefit of U.S. Provisional Application Ser. No. 61/016,428, filed on Dec. 21, 2007, which is hereby incorporated by reference in its entirety.

### BACKGROUND

The invention is directed to a method, system, and article for implementing a complex system or process.

In many fields of endeavor, an organization or individual may need to implement various systems or processes (hereinafter “processes”) in order to accomplish a task or project. Such a process may be associated with a very large number of parameters, settings, and/or design choices that may be used to implement the task or project. The problem is that given a large number of potential variability in how the process is implemented, it is often very difficult to achieve an optimal combination of variables to achieve desired results for the task or project.

Commonly, such processes are implemented on an ad hoc basis based upon the experience and knowledge of a specialist for the given task or project. This specialist will design and implement the process, and will select the specific combination of variables and parameters for the process based upon the his/her learned experience and training. The problem with this approach, however, is that the quality of the end result is highly dependent upon the competence of the particular specialist that was chosen to implement the process. This approach is also very non-systematic, not repeatable, and is fairly inefficient because of its manual nature. In addition, depending upon the area of specialty for which the process is directed, qualified and experienced specialists may be difficult to find and far outnumber the amount of work that needs to be performed.

Design of Experiments (DoE) refers to a more systematic approach that has been developed over the years to determine the relationship between different factors when implementing a process. This method was developed by Sir Ronald A. Fisher as a set of formal mathematical methodologies to implement experimental designs. The DoE method involves design experiments in which relevant factors are varied systematically. When the results of these experiments are analyzed, they help to identify optimal conditions and the factors that either do or do not influence the results. In addition, the results may be used to identify and quantify the existence of interactions between factors. Many modem organizations in almost all fields of commerce and technology now use the DoE method to design their processes and to implement their products and strategies.

The conventional approach to implementing the DoE method is to perform experiments to identify optimal combinations of factors, and to thereby remove from consideration the non-optimal factors. To explain, consider a typical process which may have several different steps from beginning to end. Each set of possible design decisions made at each step feeds to other possible design decisions at subsequent steps, such that the realm of design possibilities for the process exponentially expands and extends in a tree-like structure along many paths of possibilities. The DoE method is designed to perform experiment to identify the optimal design combinations, and to thereafter prune the non-optimal design combinations from the range of possibilities. The benefit of this approach is that it can be used to empirically identify solutions to design problems.

One drawback with this approach is that pruning significant ranges and combinations of possible solutions could be very limiting and may result in sub-optimal results if the specific experiments that were chosen were not extensive enough to address every possible or reasonable variation in the combination or range of parameters. This is particularly likely to occur in a multi-stage process in which early stage experiments cannot adequately account for design effects that occur at later stages. Therefore, it is possible that design combinations pruned at an early stage, because they produced a sub-optimal DoE results for that early stage of the process, should nevertheless have been retained because they provides a better overall results for the process when considered in light of later stages.

The standard DoE method works quite well when the input parameters are orthogonal to each other with respect to comparisons/contrasts between those parameters. Contrasts can be represented by vectors and sets of orthogonal contrasts are uncorrelated and independently distributed if the data are normal. Because of this independence, each orthogonal treatment provides different information to the others. If there are T treatments and T-1 orthogonal contrasts, all the information that can be captured from the experiment is obtainable from the set of contrasts. The problem is that many processes utilize input parameters which may be non-orthogonal by nature. Moreover, it is possible that the processes are highly non-linear.

Therefore, there is a need for an improved method and system for implementing and verifying a process.

### SUMMARY

Some embodiments of the present invention model a process as a series of steps corresponding to sets of inputs and outputs, where the inputs relates to various configurations of elements for a given step of the process. For each step in the process, one or more models are constructed that correspond to the possible parameters and samples associated with specific stages of the process. Sampling is performed to generate raw data for the models. Experimentation is performed on a significant scale to identify a set of configurations setting that should be retained for a subsequent step of the process. The selection of configuration setting for each stage of the process is not intended to prune parametric options from the process. Instead, reductions are performed which both preserve uniform and reasonably maximal coverage of data over the intended design space, while at the same time selecting configurations that achieve the desired results. In this way, the invention preserves all reasonable parametric options through all stages of the design process while also working towards an optimal solution.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF FIGURES

FIG. 1 shows a high-level flowchart of method for implementing a complex system or process.

FIG. 2 shows a flowchart of a method for performing exploration and obtaining a set of analysis data for the complex system or process.

FIG. 3 shows a flowchart of a method for performing global feasible analysis of parameter combinations for the complex system or process.

FIG. 4 shows a flowchart of a method for performing local feasible analysis of parameter combinations for the complex system or process.

FIGS. 5 and 6A-C illustrates an embodiment of the invention as applied to a simplified IC design flow or EDA tool flow.

FIG. 7 shows an architecture of an example computing system with which the invention may be implemented.

### DETAILED DESCRIPTION

Many design processes can be viewed as a tree-like progression through a series of design options, where from any given starting point there may be a spectrum of configuration options that exponentially spreads in its various perturbations through each succeeding step of the process. The general problem addressed by some embodiments of the invention is, given the wide range of combinations for the possible inputs, to select the correct combination to provide the optimal output.

Embodiments of the present invention provide approaches that model a process as a series of steps corresponding to sets of inputs and outputs, where the inputs relates to various configurations of elements for a given step of the process. For each step in the process, one or more models are constructed that correspond to the possible parameters and samples associated with specific stages of the process. Experimentation is performed on a significant scale to identify a set of configurations setting that should be retained for a subsequent step of the process. Performing these actions at each step of the process essentially results in construction of a set of parametric design flows for the overall process.

Unlike prior DoE approaches, the selection of configuration setting for each stage of the process is not intended to prune parametric options from the process. In contrast, the goal is to both preserve uniform and reasonably maximal coverage of data over the intended design space, while at the same time selecting configurations that achieve the desired results. In this way, the invention preserves a reasonably large set of parametric options through all stages of the design process while also working towards a more optimal solution.

The invention may be applied to optimize any type of complex process. For the purposes of illustration, embodiments of the invention may be described with respect to implementation of complex processes and tools for electronic design activity. It is noted however, that the described embodiments are illustrative only, and do not limit the scope of the invention unless otherwise claimed as such.

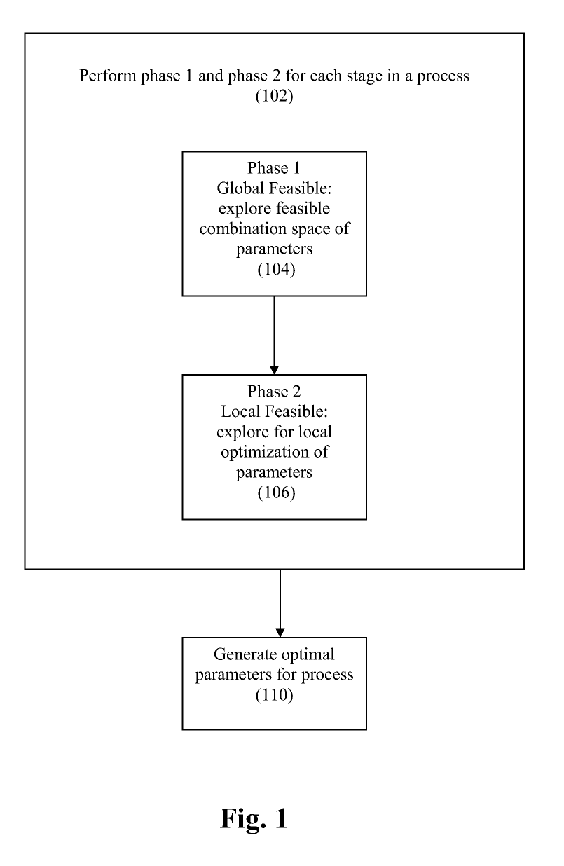

FIG. 1 shows a high-level flow of the invention according to some embodiments. The process is implemented using a two-phase procedure, where both phases are performed across some or all stages or steps of the process to be optimized (102).

The first phase pertains to a global exploration of the feasible combinations of parameters and options that may be employed for the process (104). During the first phase (104), the process (102) starts with determining the universe of possible configurations that may exist to implement the particular step of the process under consideration. This phase (104) of the method identifies what is possible to be used as inputs to the stage of the process. Modeling and experimentation is performed to generate and explore the range of possible configurations.

During the second phase, exploration within and around the parameter and option space is performed to generate a local optimum for the combinations of parameters and options for the process (106). This local feasibility analysis refines the analysis from the first phase, and will generally result in limiting the number of possible configurations around those candidate combinations identified from the first phase. The limiting action of the second phase is performed with the existing starting points in mind, but also with consideration of the new parameters that will form starting points for a next stage of the overall process (if there is to be a subsequent stage of the process). The limitations are made to identify configurations that can be implemented to optimally achieve desired design goals, while also preserving coverage of configuration options for the subsequent stage(s).

The number of iterations that is performed for each phase depends upon the specific process that is to be optimized, and may vary depending upon factors just as the number of stages, types of stages, and complexity of stages within the process. The actions within each stage may be serially performed, iteratively performed, or even recursively performed based upon the type of process that is being optimized. If there are no further stages to be performed for the process, then the last derived set of optimal configurations is generated for the process (110).

The approach is therefore a way to reduce choices between stages of the process. The reduction is done in an intelligent manner, being guided by focused analysis and identification of configuration settings that is expected to produce optimal results. However, the reduced choices are also made in a manner in which the set of remaining choices continues to provide maximal coverage over the possible input parameter space, with each configuration choice representing a wide range of possible parameter values.

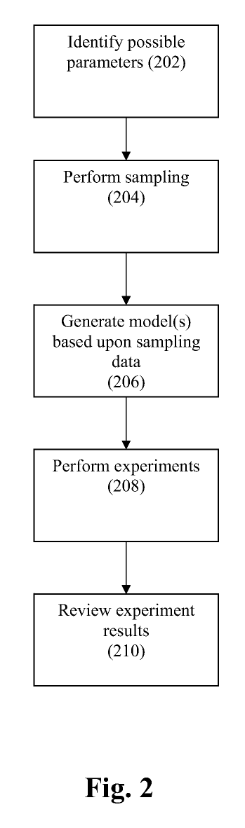

FIG. 2 shows a more detailed flow for the action of performing exploration across a combination space of design parameters and options. The method begins by identifying the configurable parameter elements that may be used to establish possible configurations (202). Examples of such configurable elements include parameters that can be varied across a range, selector parameters for a choice of options, or variables that determine next steps to be taken in the process.

Sampling is performed to generate a set of data points which can be used to analyze the configurable elements and their different configuration combinations (204). Any suitable approach can be taken to perform the sampling action. For example, the DoE method can be used to perform a range of experiments to generate hard data regarding the effect of different parameter settings upon a particular stage of the process. Formal verification techniques may be applied to verify the appropriateness and completeness of any given set of samples. Statistical analysis techniques may be used to determine the appropriateness of the rate and distribution for the sampled data.

The process or a specific stage of the process may be modeled based upon the sampling data (206). As used herein, the term “model” refers to a set of data that identifies one or more specific characteristics for a process or stage of a process. For example, for an integrated circuit (IC) design process, a model for the IC design data may relate to its functionality, behavior, effect, manufacturability, and/or usability. The model can be used to predict the effect on the process based upon variance of the parameter value. Specific examples of models in the context of IC design and manufacture include lithography, electrical analysis, timing, and chemical metal polishing (CMP) models. It also should be appreciated that the process and model are applicable to all sorts of areas and not limited to the IC design and manufacturing-related processes.

The model is generated to dynamically characterize the configurations and/or parameters as a set of transfer functions. The newly formed model is then used as a basis for performing a large set of experiments to generate and analyze possible configurations for the parameters (208). The experiments are performed on a significant scale to identify the universe of possible parameter configurations and are analyzed to determine their result/effect upon the process (210). Each stage of the process can therefore be represented as a collection of experiments. The results of the experiments establish the set of feasible configurations. This means that at each stage of the method, it will be known the set of parameter configurations that will produce the highest quality results.

Model reduction techniques can be applied to reduce the number of different configuration settings that are to be employed in a subsequent stage of the process. Model reduction is employed to reduce the possible configurations in a way that both preserves uniform and reasonably maximal coverage of data over the intended design space while at the same time selecting configurations that achieve the desired results. For a given input set of parameter space, not every variant of input will produce a significant variant of output. In all likelihood, only a relatively few key variants on input will provoke a significant change in the output. Model order reduction is applied to minimize and reduce gross redundancies to generate models that are both efficient and fast.

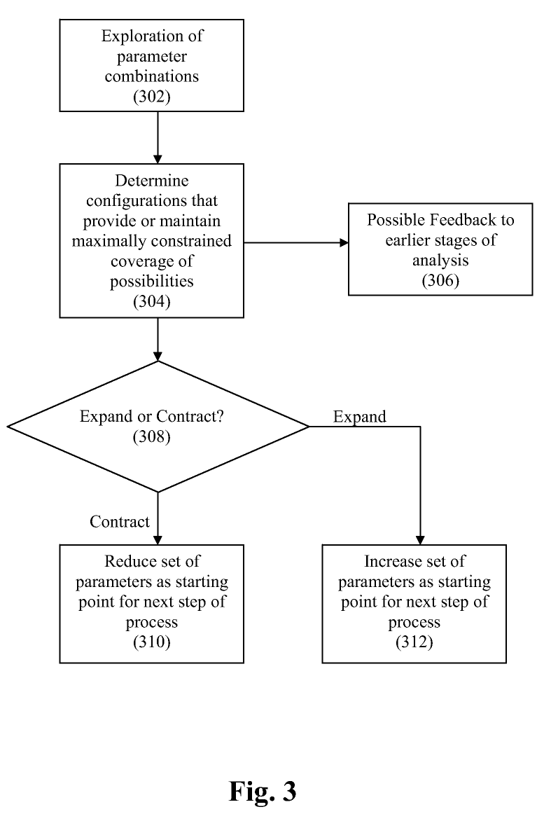

FIG. 3 shows a detailed flow that can be used to implement the first phase 104 of FIG. 1 to optimize a process. The goal is to perform exploration to identify and analyze the globally feasible sets of possible solutions within the universe of possible solutions, and then to generate a set of possible parameters and options that can be used for the second phase 106 of the analysis.

Initially, an exploration is made of the different possible parameter combinations (302). For example, the process described with respect to FIG. 2 may be employed to perform this type of exploration.

Next, the exploration results are analyzed with careful consideration to identify specific characteristics that would be considered desirable or optimal in the results (304). This can be performed by considering and expressing the different option in terms of cost functions for each parameter and/or combinations of multiple parameters. Different result values can be analyzed based upon their expected cost and their “tradeoff” effect as inter-compared and inter-related to other parameter settings. Gradients between different values can be mathematically established and analyzed to generate performance graphs to tune the analysis and further selection of optimal solutions. The calculated gradients can also be used to determine additional experiments to be performed. Results of this analysis can also be used as feedback to improve the accuracy of previously generated models.

The experimental results are also analyzed to identify a set of configurations that provide reasonably maximal and representative coverage over the possible input space for the input parameters. This analysis is intended to maintain a reasonable view of the entire option space, without restricting possibly beneficial options from subsequent stages of the process. Each parameter that is selected will represent a range of possible parameter values. For each step, the method seeks to look at the maximum feasible space of configurations that can be implemented. Therefore, the goal is to keep the range of possible configurations as reasonably broad as possible, while still satisfying the goal of selecting configurations that will optimally satisfy the desired output results.

Based upon this analysis, a determination is made whether to expand or to reduce the set of parameters and options within the combination space (308). In some cases, it may be desirable to increase the set of parameters and options (312). This increase may occur because the maximum feasible space of possible values cannot be achieved with the existing set of candidate parameters. For example, the existing identified sets of parameters may be statistically skewed from a distribution viewpoint and is concentrated within only a certain portion of the solution space. In this scenario, the set of possible parameters may be expanded with the goal of providing greater distribution of parameters across the solution space.

Similarly, it may be desirable to decrease the set of parameters and options (310). This decrease may occur because there are more presently identified parameters than needed to provide the maximum feasible space of possible values. For example, the existing identified sets of parameters may be so numerous that different combinations of parameters are statistically indistinct from one another. In this scenario, the set of possible parameters may be reduced without meaningfully sacrificing coverage over the feasible solution space.

Based upon analysis actions taken in 304, it is possible to implement a feedback loop to optimize the earlier actions taken in the invention (306). Feedback would be provided, for example to the actions taken in the exploration stage 302. Such feedback can be used to modify or re-calibrate models based upon the experimental results. The feedback can also be used to modify the type or number of inputs and parameters employed for the exploration actions. In addition, feedback can be used to improve the distribution or rate of sampling during the data sampling actions.

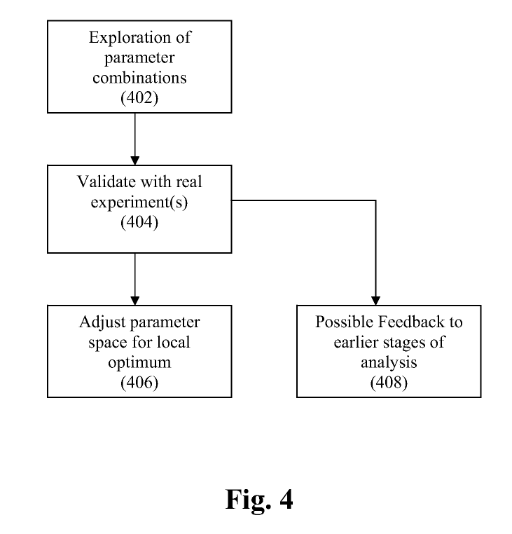

FIG. 4 shows a detailed flow that can be used to implement the second phase 106 of FIG. 1 to optimize a process. The global set of possible parameters and options from the first phase 104 is analyzed, and exploration is performed to generate a local optimum for the combinations of parameters and options for the process. As noted above, local feasibility analysis is utilized to refine the analysis from the first phase and to limit the number of possible configurations around those candidate combinations identified from the first phase. Configurations are identified that can be implemented to optimally achieve desired design goals, while also preserving coverage of configuration options for the subsequent stage(s) of the process.

Exploration is made of the different possible parameter combinations (402). For example, the process described with respect to FIG. 2 may be employed to perform this type of exploration. This exploration action may involve experimentation using one or more models relating to the process being optimized. Since the experimentation is based upon modeling, it is possible that real-world results may differ either minimally or significantly from the predicted results of the models. Therefore, validation may be performed upon the experimental results (404). For certain types of processes or process stages, validation may be performed by conducting real-world experiments for the process or process stage under examination.

For example, consider the stage of an IC design process to implement the physical design of a layout for an integrated circuit. Given many different possible combinations of layout parameters for the IC design, lithography simulation can be used to experimentally determine the predicted effects and performance of each combination of layout parameters. The lithography simulations are based upon a set of lithography models that may have been generated by a fabrication facility or manufacturer. The predicted effects and results from simulation can be validated by performing actual experiments with the manufacture of actual chips/wafers with the different combinations of layout parameters on those chips or wafers.

Based upon the validation results, the parameter space may be adjusted to provide a local optimum for the process or stage of the process under consideration (406). This action is performed by exploring the parameter space, and based upon validation results, determining the number and/or type of configurations around those parameters can be implemented to optimally achieve desired design goals. Essentially, a refinement action is being performed to identify local feasibly of an optimized set of parameters to narrow the parameter space while also preserving coverage of configuration options.

For the local optimization actions of the second stage 106, it is also possible to implement a feedback loop to optimize the earlier actions taken in the invention (408). Feedback would be provided, for example to the actions taken in the exploration stage 402. Such feedback can be used to modify or re-calibrate models based upon the experimental results. The feedback can also be used to modify the type or number of inputs and parameters employed for the exploration actions. In addition, feedback can be used to improve the distribution or rate of sampling during the data sampling actions.

To illustrate the invention, consider the process to create a new cellular phone product. There may be many decisions that need to be made at the global level and that are discrete in nature. For example, the designer of the phone product will need to select the specific type of processor, processor core or system-on-chip (SOC) that will be employed within the phone product. There may be many different vendors and types of designs for these processors, SOC, or cores, with the choice of a specific vendor or design having a very significant impact upon the performance of the product and upon the later stages of the design. Another top level decision may be the selection of the type of power source or battery that is used for the phone product. Even at the top level decision points, there may be continuous variables as well, where a decision must be made for each of these top level decisions. Then for each of these, additional decisions must be made as well. There are also many design decisions and design parameters that are more local in nature but which can also significantly affect the eventual performance of the phone product. For instance, the placement and routing of geometries on the layout for the IC chip will need to be designed and developed for the phone product.

As another illustration of the invention, consider the historical example of a design of a process and/or system with the main goal to send a man to the moon. First, one would need to decide on the main method to accomplish this goal. Assume that there are three choices, including a direct trip, a rendezvous in earth orbit, or a rendezvous in moon orbit. This is a discrete decision—interpolation does not apply to these choices. However at this top level there may be continuous variables as well, such as how much margin to allow for future growth, and top level discrete variables that do not directly interact with the main decision, such as how many crew are required. A decision must be made for each of these top level decisions. For example, a decision must be made to decide how many stages in the rocket, which is also a discrete decision. For each of these stages, a decision must be made about what fuel to use, which is also a discrete decision. Then for each of these, additional decisions must be made regarding state mass, engine thrust, and many other parameters. These are continuous variables that should be optimized. Many of these parameters may be non-linear by nature.

The problem with each of these examples is that there are many possible combinations, and no existing tools to adequately help make sure the designer has explored them correctly. Moreover, there are no adequate tools to ensure adequate coverage of the possible alternatives, nor adequate optimization of the alternative selected. Conventionally, this type of design process is entrusted to experienced designers, who must rely in a manual and/or ad hoc manner upon their personal experiences to implement the correct design. This type of ad hoc process is prone to or the failure to identify alternatives that could prove useful. The designer could also use a more systemic process such as the DoE process, but DoE processes often fail to product a correct result if the problem being addressed is highly non-linear or utilizes input parameters which may be non-orthogonal by nature. In addition, conventional approaches could not allow alternative solutions to be viewed based upon parameter values.

Once a designer has actually made a discrete decision, then there are many tools (such as EDA place and route tools in the case of IC design) that the designer can use to implement the decisions. The problem is that if the designer made a sub-optimal choice at the top-level, conventional tools will not thereafter allow the designer to recognize this fact and to identify a more optimal solution from among the previous choices at the top level.

Embodiments of the present invention provide a system and method for designing complex systems and processes with the ability to specify a decision tree containing various levels of decisions. The alternative within the decision tree allows the alternatives to be specified as discrete or continuous. The structure of the tree may depend on the parameter values as well.

According to some embodiments, a user interface is provided that keeps track of decisions made, and allows use to visualize which branches have been explored, and which have not. The user interface also allows the user to try various means of analysis of the data, in order to decide how to proceed. The user interface can include enumeration of results, e.g., for discrete systems, and response surface modeling for continuous variables. Moreover, the user interface can be used to allow the user to specify how to proceed, e.g., if some alternatives need to be expanded or some pruned. If pruned, the system allows explanation to be entered so that someone following on can see why the decision was made, in case it needs to be re-visited. If expanding, various options may make sense: optimize on the response surface model, perform more experiments to refine the model, perform more experiments to examine a discrete model. For example, consider for each of cases 1, 2, or 3, it may be useful to vary parameter P over a 5:1 range using 6 test cases. Then, the method and system could fit a quadratic model to the result, find the minimum of the model, and then re-run that specific case to check the accuracy.

Embodiments of the invention can be used to record the basic of each higher level step. Information can be recorded for any step, and not just pruned steps. The recorded data could include, for example, information about “who”, “what decision”, “when”, “why”, and “how it was evaluated.” An interface can be provided to access this information, e.g., to display, search, view as a matrix, and/or generate reports.

Users can be given the ability to specify the main concerns for each higher level choice. For example, a low-power process might need study to see if it can run fast enough, a high power process might mainly have a question of battery life, and the use of a more advanced process node might be mainly a question of cost. Thus each of these high level decisions might require a different low level study.

In addition, the user can be provided with the capability to add a new high level choice. For example, for the process to design a cellular telephone, if a new cellular processor is being released as IP, then the user can be given the option to reconsider a prior decision to select a processor core 1 or processor core 2. At least some of the low-level settings can be automatically applied to this new high level choice. For example, if one of the lower level steps was to “compile code and see how large it is,” and this lower level step was previously applied before for the processor core 1 or processor core 2 decision, then it can be automatically reapplied for the new cellular processor. This can be implemented by specifying the lower level evaluation as a process or macro, or providing a replay capability, so the evaluation can be applied to new top level choices if they show up. New concerns can also be raised, as in the previous point.

If new detailed results look worse than some estimated cost of a previously pruned approach, then the embodiment can automatically suggest re-investigating the old high-level choice. Estimations can be performed or provided of any cost, and/or effect, e.g., by manual intervention. This can be provided with or without a predicted margin of error. This can be used to compare existing approaches with new ideas that are not yet available in fully detailed form.

Returning back to the example of designing a cellular phone product, the invention can be applied to create a decision tree whereby possible configurations regarding the choice of a specific processor core or SOC preserves different options for purposes of exploration. During local feasibility analysis, specific parameters for each of those choices are assessed as well, e.g., with regard to the different layout and placement/routing parameters for the different core or SOC choices. Experimentation can be performed to analyze and identify the set of configurations that are expected to function properly for the phone product. This can also be used to eliminate parameter choices or combinations for the possible core or SOC designs which do not preserve reasonably maximal coverage of the input space or provide for acceptable design solutions. Validation can also result from this produces to verify the accuracy of the decisions and experimental data. The analysis would step through the design of the different components and abstraction levels of the phone product, and refinements made to the design, until the optimal design for the phone product has been generated. In this manner, the designer is guided through the process of generating the phone product design, without the risk of making undiscovered bad choices at early stages that eliminate better choices at a later stage of the design process. Instead, since parametric options are not pruned from each stage, the end result is a product design that has maximally optimized the design based with consideration of the entire input space.

As another illustration of an embodiment, consider if the invention is applied to implement the process to create an IC design, e.g., using one or more electronic design automation (EDA) tools. A semiconductor integrated circuit has a large number of electronic components, such as transistors, logic gates, diodes, wires, etc., that are fabricated by forming layers of different materials and of different geometric shapes on various regions of a silicon wafer. The various components of an integrated circuit are initially defined by their functional operations and relevant inputs and outputs. From the HDL or other high level description, the actual logic cell implementation is typically determined by logic synthesis, which converts the functional description of the circuit into a specific circuit implementation. The logic cells are then “placed” (i.e., given specific coordinate locations in the circuit layout) and “routed” (i.e., wired or connected together according to the designer's circuit definitions). The placement and routing software routines generally accept as their input a netlist that has been generated by the logic synthesis process. This netlist identifies the specific logic cell instances from a target standard cell library, and describes the specific cell-to-cell connectivity.

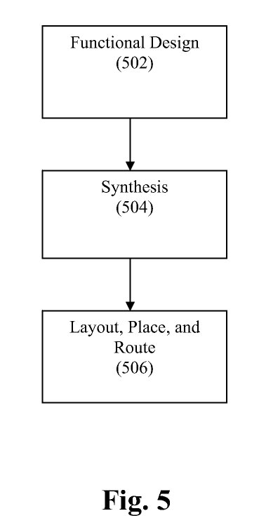

FIG. 5 shows a fairly simplistic view of this IC design process. For this example, the process being implemented includes three stages, a functional design stage (502), a logic synthesis stage (504), and a layout, place, and route stage (506). Those of ordinary skill in the art will of course realize that the invention may also be applied to other IC design flows or EDA tool flows where such flows are implemented using different combination of stages and at the same or different levels of granularity.

For each stage of this IC design process, there may be a very large number of possible combinations of possible parameter values that can be used as an input to that design at each stage. The outputs of one stage serve as inputs to the next stage of the IC design process, along with a very large number of additional input parameters unique to that new stage which also need to be considered for the input space of that stage. Therefore, the overall effect of considering multiple stages results in many millions or billions of possible parameter combinations, where large numbers of possible parameter configurations at one stage exponentially feeds to other large numbers of possible parameter configurations at multiple other stages.

Embodiments of the invention are applied to intelligently narrow the amount of parameter setting at each stage which is fed to additional stages of the process. This narrowing serves to reduce the set of parameter possibilities that need to be considered to a reasonably compact grouping for a subsequent stage of the IC design process. At the same time, the reduction is made in a manner that furthers the design goals and selection of an optimal result.

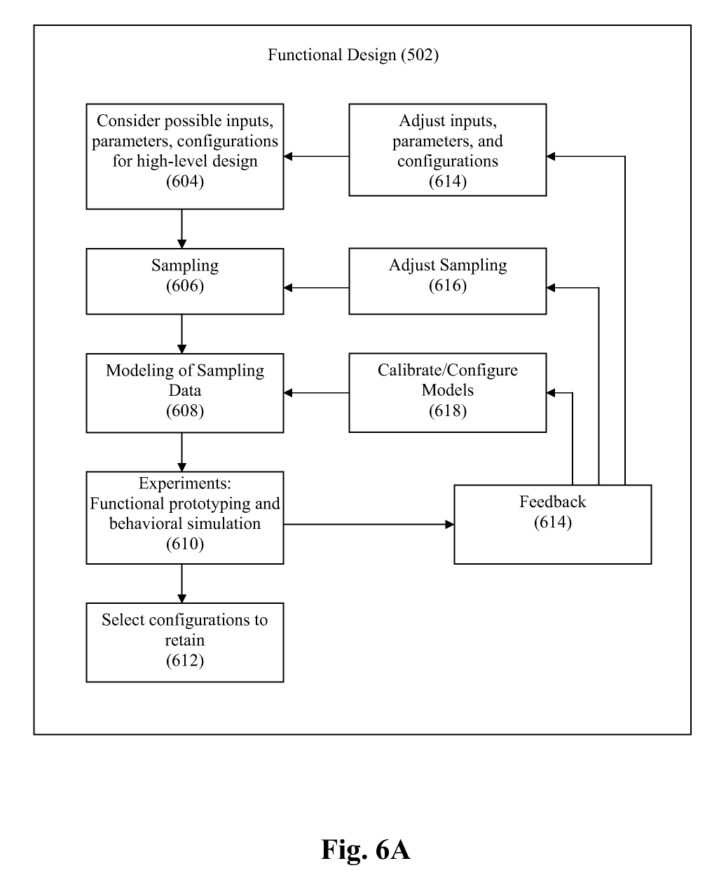

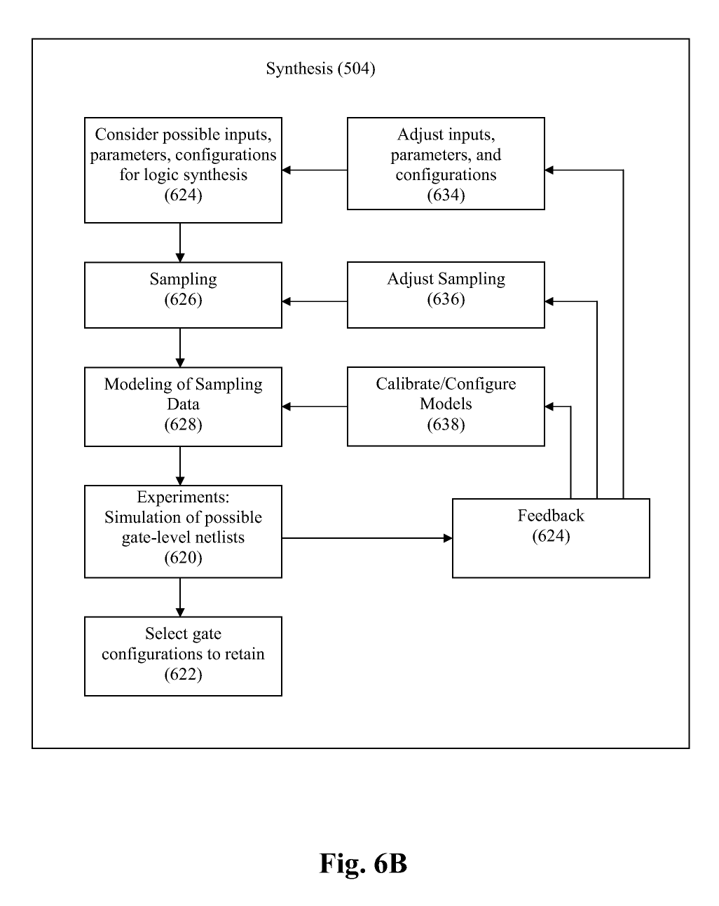

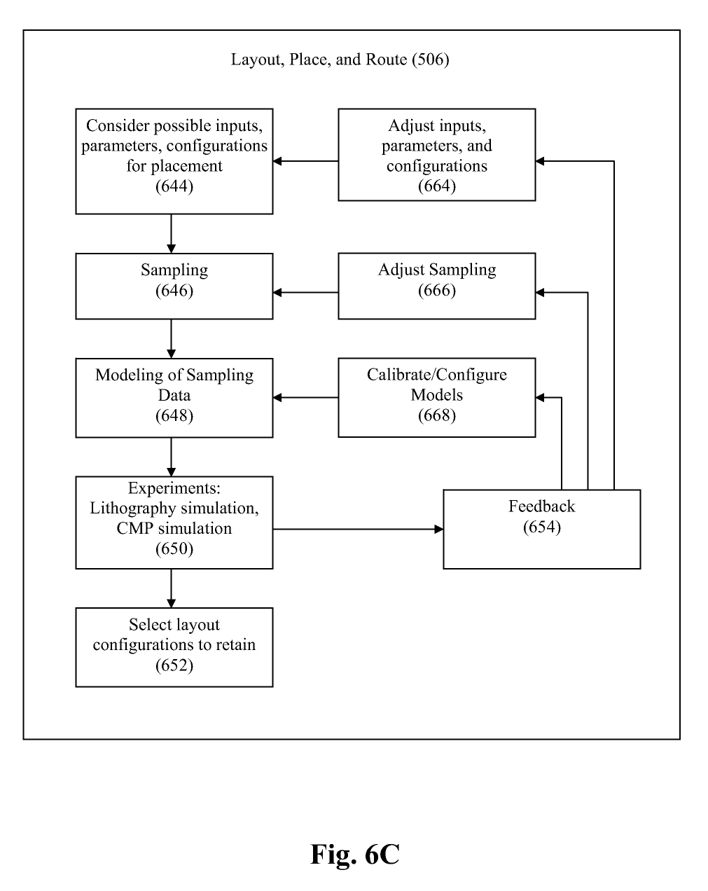

Referring to FIG. 6A, for the functional design stage (502), the possible categories of input parameters and configurations are first identified for the high-level design (604). These would include, for example, behavioral, functional, and architectural parameters and operations for the IC design. Input and output parameters may also be specified for the IC design.

Next, sampling is performed to generate performance data relating to these parameters and operations (606). Such sampling can be obtained by implementing a DoE study of different variants/configurations of those parameters and operations upon the output behavior of the expected IC design.

One or more models are created which correspond to the sampling data for those behavioral, functional, and architectural parameters and operations (608). A large number of experiments are then performed using the created models (610). Such experiments could include, for example, functional prototyping and behavioral simulation.

The results of the experiments are analyzed to identify sets of configurations that will optimally satisfy the original design intentions for the IC design. In addition, the method looks for sets of configurations that maintain the maximum feasible space of possible variants that can be implemented. Based upon this analysis, a set of configurations are selected to be retained (612). For example, the initial set of many millions of possible parameter configurations may be reduced (or increased) to a set of 100 to 1000 different parameter configurations for the functional design according to one embodiment. This optimized set has specific values elected to retain representation for a reasonably large number of those many millions of possible combinations from the initial set. The selected set of configurations can be maintained in any suitable format, e.g., in an hardware description language HDL format. For embedded systems design, the selected set of configurations may include both hardware and software configuration parameters.

A feedback loop may be implemented to optimize the earlier actions taken in the process (614). Feedback can be used to modify or re-calibrate models based upon the experimental results (618). The feedback can also be used to modify the type or number of inputs and parameters employed for the exploration actions (614). In addition, feedback can be used to improve the distribution or rate of sampling during the data sampling actions (616).

The reduced (or increased) set of parameter configurations is output from the functional design stage (502) as inputs to the subsequent logic synthesis stage (504). Referring to FIG. 6B, at the logic synthesis stage (504), the possible input parameters and configurations are identified for performing logic synthesis (624). These input parameters and configurations include, for example, the output from the previous functional design stage (502) as well as additional inputs specific to the logic synthesis stage, e.g., technology mapping parameters.

Sampling is performed to generate performance data relating to these parameters and operations (626). Such sampling can be obtained by implementing a DoE study of different variants/configurations of the logic synthesis parameters and operations upon the output behavior of the expected IC design. For example, sampling may be performed to acquire data relating to the performance, suitability, and/or correctness of different parameters and configurations as compared against delay/timing measurements, logic correctness checking, design rule correctness measurement, and area versus delay tradeoffs.

One or more models are created which correspond to the sampling data for those logic synthesis parameters and operations (628). For example, models may be created that correspond to delay/timing effects, logic correctness variations, design rule compliance, and area versus delay probabilities.

A large number of experiments are then performed using the created models (620). Such experiments could include, for example, timing analysis of different combinations of gate-level netlist configurations to analyze expected timing results.

The results of the experiments are analyzed to identify sets of configurations that will optimally satisfy the original design intentions for the IC design. In addition, the method looks for sets of configurations that maintain the maximum feasible space of possible variants that can be implemented. Based upon this analysis, a set of configurations are selected to be retained (622). As before, the initial set of many possible parameter configurations may be reduced (or increased) to a much smaller set of 100 to 1000 different parameter configurations for the gate level design according to one embodiment. The selected set of configurations can be maintained in any suitable format, e.g., in an gate-level checklist.

A feedback loop may be implemented to optimize the earlier exploration actions taken in the process (624). Feedback can be used to modify or re-calibrate models based upon the experimental results (638). The feedback can also be used to modify the type or number of inputs and parameters employed for the exploration actions (634). In addition, feedback can be used to improve the distribution or rate of sampling during the data sampling actions (636).

Referring to FIG. 6C, for the subsequent stage of layout, place, and route (506), the possible input parameters and configurations are identified for performing such physical design activities (644). These input parameters and configurations include, for example, the output from the previous synthesis stage (504) as well as additional inputs specific to the present physical design stage.

Sampling is performed to generate performance data relating to these parameters and operations (646). Such sampling can be obtained by implementing a DoE study of different variants/configurations of the physical design parameters and operations upon the output behavior of the expected IC design. Test chips can be created having structure corresponding to different physical design configurations. The test chips can be analyzed to generate sampling data for this stage of the process.

One or more models are created which correspond to the sampling data for those logic synthesis parameters and operations (648). For example, such model at the physical design stage for an IC design may relate to the manufacturability, performance, and/or usability of different layout configurations. The model can be used to predict the effect on the manufactured IC device based upon variance of layout parameter value.

A large number of experiments are then performed using the created models (650). Such experiments could include, for example, lithography simulation, CMP simulation, timing analysis, and electrical simulation/extraction. The simulations identify and analyze the expected manufacturing and performance results corresponding to a large number of perturbations in the layout parameter input space.

The results of the experiments are analyzed to identify sets of configurations that will optimally satisfy the original design intentions for the IC design. In addition, the method looks for sets of configurations that continue to analyze the maximum feasible space of possible variants that can be implemented. Based upon this analysis, a set of configurations are selected to be retained (652). The selected set of configurations can be maintained in any suitable format, e.g., in the GDSII formal. At the end of this process, the output should correspond to a set of configuration settings which optimally can be used to implement the IC design.

Similar to earlier stages, a feedback loop may be implemented to optimize the earlier exploration actions taken in the process (654). Feedback can be used to modify or re-calibrate models based upon the experimental results (668). The feedback can also be used to modify the type or number of inputs and parameters employed for the exploration actions (664). In addition, feedback can be used to improve the distribution or rate of sampling during the data sampling actions (666).

The invention is applicable to any suitable field of endeavor and to the implementation of any complex system or process. For example, embodiments of the invention are particularly suitable to the field of software implementation, debugging, and system validation. For software implementation, the different design options at each stage of the design can be analyzed using the present sampling, modeling, and experimentation methods to narrow the scope of options to an optimal set of design parameters. Similarly, for debugging purposes, different verification and testing parameters can be selected based upon the present sampling, modeling, and experimentation approaches to identify specific test parameters and test vectors that should be employed for debugging an item of software. When software is released as different versions, the present invention can be applied to perform release validation. In effect, different versions of the software may be experimentally run to determine which of the different release options provide better or more stable performance results.

The invention may also be applied to optimize the design of mixed hardware and software systems. Conventional approaches to the design of embedded software is fraught with inaccuracies and inefficiencies due to the inherent complexities of a design process that needs to co-design and co-verify a system that includes both software and hardware components. The problem relates to the large number of possible input parameters for both the hardware side and the software side, and well as inherent complexity of attempting to analyze interfaces between these two types of components. Embodiments of the present invention minimizes this complexity by modeling the input space for each stage of the design process, while performing experimentation to identify the much smaller set of representative parameter configurations that optimally provides desired results. In this way, even the most complex process, such as the design of a system having embedded software, can be systematically addressed in a coherent manner which preserves all reasonable design options and allows analysis of those design options regardless of the large number or complexity of inputs that need to be considered.

### System Architecture Overview

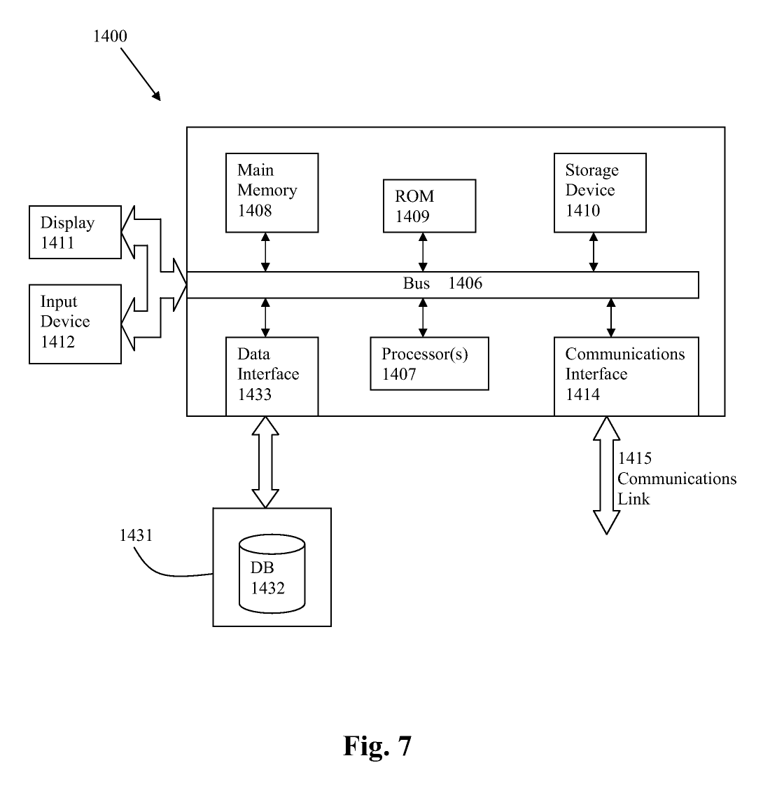

FIG. 7 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A computer program product that includes a computer readable medium, the computer readable medium comprising a plurality of computer instructions which, when executed by a processor, cause the processor to perform a process for implementing a system or process, the process comprising:
performing global exploration of feasible combinations of parameters for the system or process;
generating a local optimum for the combinations of the parameters;
generating a more optimal configuration of parameters for the system or process; and
displaying the more optimal configuration of parameters on a display device or storing the more optimal configuration of parameters in a data structure configured on a computer readable medium.

2. The computer program product of claim 1 further comprising:
identifying possible parameters;
performing sampling;
generating one or more models; and
performing one or more experiments.

3. The computer program product of claim 2 in which the possible parameters comprises configurable elements which can be varied across a range, from a choice of options, or variables that determine next steps in the process.

4. The computer program product of claim 2 in which the sampling generates a set of data points for the possible parameters.

5. The computer program product of claim 2 in which the one or more models corresponds to electronic designs.

6. The computer program product of claim 5 in which the one or more models comprises a lithography model, electrical analysis model, timing model, or CMP model.

7. The computer program product of claim 2 in which the one or more experiments are used to analyze effects of the possible parameters upon the system or process.

8. The computer program product of claim 1 in which the global exploration of the feasible combinations of the parameters is performed to determine configurations that provide or maintain maximally constrained coverage.

9. The computer program product of claim 8 in which the global exploration of the feasible combinations of the parameters is further performed to determine whether to expand or contract the parameters.

10. The computer program product of claim 1 in which the local optimum is generated by exploring the combinations of the parameters, validating with experimentation, and adjusting the parameters to obtain the local optimum.

11. The computer program product of claim 1 implemented to optimize the process of implementing an electronic product, in which functional design, synthesis, and layout of the electronic product are addressed.

12. A computer implemented method for implementing a system or process, comprising:
performing global exploration of feasible combinations of parameters for the system or process;
generating a local optimum for the combinations of the parameters;
generating a more optimal configuration of parameters for the system or process; and
displaying the more optimal configuration of parameters on a display device or storing the more optimal configuration of parameters in a data structure configured on a computer readable medium.

13. The method of claim 12 further comprising:
identifying possible parameters;
performing sampling;
generating one or more models; and
performing one or more experiments.

14. The method of claim 13 in which the possible parameters comprises configurable elements which can be varied across a range, from a choice of options, or variables that determine next steps in the process.

15. The method of claim 13 in which the sampling generates a set of data points for the possible parameters.

16. The method of claim 13 in which the one or more models corresponds to electronic designs.

17. The method of claim 16 in which the one or more models comprises a lithography model, electrical analysis model, timing model, or CMP model.

18. The method of claim 13 in which the one or more experiments are used to analyze effects of the possible parameters upon the system or process.

19. The method of claim 12 in which the global exploration of the feasible combinations of the parameters is performed to determine configurations that provide or maintain maximally constrained coverage.

20. The method of claim 19 in which the global exploration of the feasible combinations of the parameters is further performed to determine whether to expand or contract the parameters.

21. The method of claim 12 in which the local optimum is generated by exploring the combinations of the parameters, validating with experimentation, and adjusting the parameters to obtain the local optimum.

22. The method of claim 12 implemented to optimize the process of implementing an electronic product, in which functional design, synthesis, and layout of the electronic product are addressed.

23. A system for implementing a design, comprising:
one or more processors that processes computer programming instructions for performing global exploration of feasible combinations of parameters for the system or process, generating a local optimum for the combinations of the parameters, and generating a more optimal configuration of parameters for the system or process; and
a memory for storing the more optimal configuration of parameters.

24. The system of claim 23 in which the one or more processors further processes the computer program code for identifying possible parameters, performing sampling, generating one or more models, and performing one or more experiments.

25. The system of claim 24 in which the possible parameters comprises configurable elements which can be varied across a range, from a choice of options, or variables that determine next steps in the process.

26. The system of claim 24 in which the sampling generates a set of data points for the possible parameters.

27. The system of claim 24 in which the one or more models corresponds to electronic designs.

28. The system of claim 27 in which the one or more models comprises a lithography model, electrical analysis model, timing model, or CMP model.

29. The system of claim 24 in which the one or more experiments are used to analyze effects of the possible parameters upon the system or process.

30. The system of claim 23 in which the global exploration of the feasible combinations of the parameters is performed to determine configurations that provide or maintain maximally constrained coverage.

31. The system of claim 30 in which the global exploration of the feasible combinations of the parameters is further performed to determine whether to expand or contract the parameters.

32. The system of claim 23 in which the local optimum is generated by exploring the combinations of the parameters, validating with experimentation, and adjusting the parameters to obtain the local optimum.

33. The system of claim 23 implemented to optimize the process of implementing an electronic product, in which functional design, synthesis, and layout of the electronic product are addressed.
